(19) United States
(12) Patent Application Publication
(10) Pub. No.: US 2024/0361841 A1
(43) Pub. Date: Oct. 31, 2024

(54) NON-GESTURE REJECTIONS USING RADAR

(71) Applicant: Samsung Electronics Co., Ltd., Suwon-si (KR)

(72) Inventors: Saifeng Ni, Santa Clara, CA (US); Vutha Va, Plano, TX (US); Priyabrata Parida, Dallas, TX (US); Boon Loong Ng, Plano, TX (US)

(21) Appl. No.: 18/607,178

(22) Filed: Mar. 15, 2024

Related U.S. Application Data
(60) Provisional application No. 63/462,834, filed on Apr. 28, 2023.

(51) Int. Cl. G06F 3/01; G01S 13/88

(52) U.S. Cl. CPC G06F 3/017; G01S 13/88

(57) ABSTRACT

An electronic device includes a transceiver configured to transmit and receive radar signals, and a processor operatively coupled to the transceiver. The processor is configured to extract a plurality of feature vectors from a plurality of radar frames corresponding to the radar signals, identify an activity based on the plurality of feature vectors, and determine whether the identified activity corresponds with a non-gesture. The processor is further configured to, if the activity fails to correspond with a non-gesture, identify a gesture that corresponds with the activity, and perform an action corresponding with the identified gesture.

### CROSS-REFERENCE TO RELATED APPLICATION(S) AND CLAIM OF PRIORITY

This application claims priority under 35 U.S.C. § 119 (e) to U.S. Provisional Patent Application No. 63/462,834 filed on Apr. 28, 2023. The above-identified provisional patent application is hereby incorporated by reference in its entirety.

### TECHNICAL FIELD

This disclosure relates generally to electronic devices. More specifically, this disclosure relates to apparatuses and methods for non-gesture rejections in gesture recognition using mm Wave radar.

### BACKGROUND

Voice and gestural interactions are becoming increasingly popular in the context of ambient computing. These input methods allow the user to interact with digital devices, e.g., smart TVs, smartphones, tablets, smart home devices, AR/VR glasses etc., while performing other tasks, e.g., cooking and dining. Gestural interactions can be more effective than voice, particularly for simple interactions such as snoozing an alarm or controlling a multimedia player. For such simple interactions, gestural interactions have two main advantages over voice-based interactions, namely, complication and social-acceptability. First, the voice-based commands can often be long, and the user has to initiate with a hot word. Second, in quiet places and during conversations, the voice-based interaction can be socially awkward.

Gestural interaction with a digital device can be based on different sensor types, e.g., ultrasonic, IMU, optic, and radar. Optical sensors give the most favorable gesture recognition performance. The limitations of optic sensor based solutions, however, are sensitivity to ambient lighting conditions, privacy concerns, and battery consumption. Hence, optic sensor based solution have the inability to run for long periods of time. LIDAR based solutions can overcome some of these challenges such as lighting conditions and privacy, but the cost is still prohibitive (currently, only available in high-end devices).

### SUMMARY

This disclosure provides apparatuses and methods for non-gesture rejections in gesture recognition using mmWave radar.

In one embodiment, an electronic device is provided. The electronic device includes a transceiver configured to transmit and receive radar signals, and a processor operatively coupled to the transceiver. The processor is configured to extract a plurality of feature vectors from a plurality of radar frames corresponding to the radar signals, identify an activity based on the plurality of feature vectors, and determine whether the identified activity corresponds with a non-gesture. The processor is further configured to, if the activity fails to correspond with a non-gesture, identify a gesture that corresponds with the activity, and perform an action corresponding with the identified gesture.

In another embodiment, a method of operating an electronic device is provided. The method includes transmitting and receiving radar signals, extracting a plurality of feature vectors from a plurality of radar frames corresponding to the radar signals, identifying an activity based on the plurality of feature vectors, and determining whether the identified activity corresponds with a non-gesture. The method further includes, if the activity fails to correspond with a non-gesture, identifying a gesture that corresponds with the activity, and performing an action corresponding with the identified gesture.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIG. 2 illustrates an example electronic device according to embodiments of the present disclosure;

FIG. 3 illustrates an example monostatic radar according to embodiments of the present disclosure;

FIG. 4 illustrates an example of a mmWave monostatic FMCW radar according to embodiments of the present disclosure;

FIG. 5 illustrates an example of a radar transmission timing structure according to embodiments of the present disclosure;

FIG. 6 illustrates an example of a radar-based gesture recognition solution according to embodiments of the present disclosure;

FIG. 7 illustrates an example gesture set according to embodiments of the present disclosure;

FIG. 8 illustrates an example of a radar-based gesture recognition solution according to embodiments of the present disclosure;

FIG. 9 illustrates a process for post ADM gating according to embodiments of the present disclosure;

FIG. 10 illustrates an example of a TVD and a TAD according to embodiments of the present disclosure;

FIG. 11 illustrates a process for angle based early detection identification according to embodiments of the present disclosure;

FIG. 12 illustrates a process for a first stage of estimating gesture start and end according to embodiments of the present disclosure;

FIG. 13 illustrates a process for determining whether a target is within an FoV according to embodiments of the present disclosure;

FIG. 14 illustrates an example of a distance feature having noise on its boundaries according to embodiments of the present disclosure;

FIG. 15 illustrates a process for a second stage of estimating gesture start and end according to embodiments of the present disclosure;

FIG. 16 illustrates an example of boundary noise according to embodiments of the present disclosure;

FIG. 17 illustrates an example of single slope feature vectors according to embodiments of the present disclosure;

FIG. 18 illustrates a process for estimating slopes according to embodiments of the present disclosure;

FIG. 19 illustrates an example of a radar-based gesture recognition solution according to embodiments of the present disclosure;

FIG. 20 illustrates a process for gesture-based post ADM gating according to embodiments of the present disclosure; and

FIG. 21 illustrates a method for non-gesture rejections in gesture recognition according to embodiments of the present disclosure.

### DETAILED DESCRIPTION

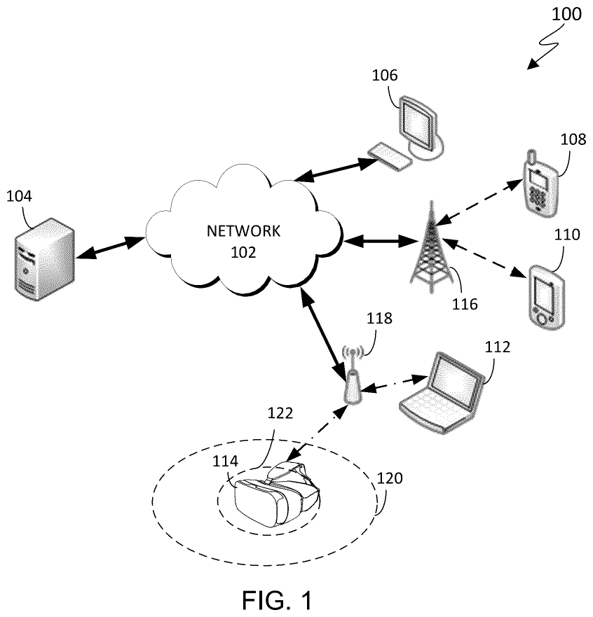

FIGS. 1 through 21, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged micro-gesture recognition system.

The superior spatial and Doppler resolution of Millimeter wave (mmWave) radars has opened up new horizons for human-computer interaction (HCI), where smart devices, such as smartphones, can be controlled through micro-gestures. The gesture-based control of the device is enabled by the gesture recognition module (GRM), which includes multiple functional blocks that leverage many machine learning-based models for the accurate identification and classification of a valid gesture activity performed by the user. One of the scenarios in the micro-gesture recognition system is the hand approaching the mmWave radar device, performing the gesture, and moving away from the device. Although very specific, this dynamic gesture input scenario may be frequently encountered. This disclosure provides an efficient solution to handle this specific scenario.

FIG. 1 illustrates an example communication system according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, AR/VR glasses, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and AR/VR glasses 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can emit and collect radar signals via a radar transceiver. In certain embodiments, the client devices 106-114 are able to sense the presence of an object located close to the client device and determine whether the location of the detected object is within a first area 120 or a second area 122 closer to the client device than a remainder of the first area 120 that is external to the second area 122. In certain embodiments, the boundary of the second area 122 is at a predefined proximity (e.g., 5 centimeters away) that is closer to the client device than the boundary of the first area 120, and the first area 120 can be a within a different predefined range (e.g., 30 meters away) from the client device where the user is likely to perform a gesture.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

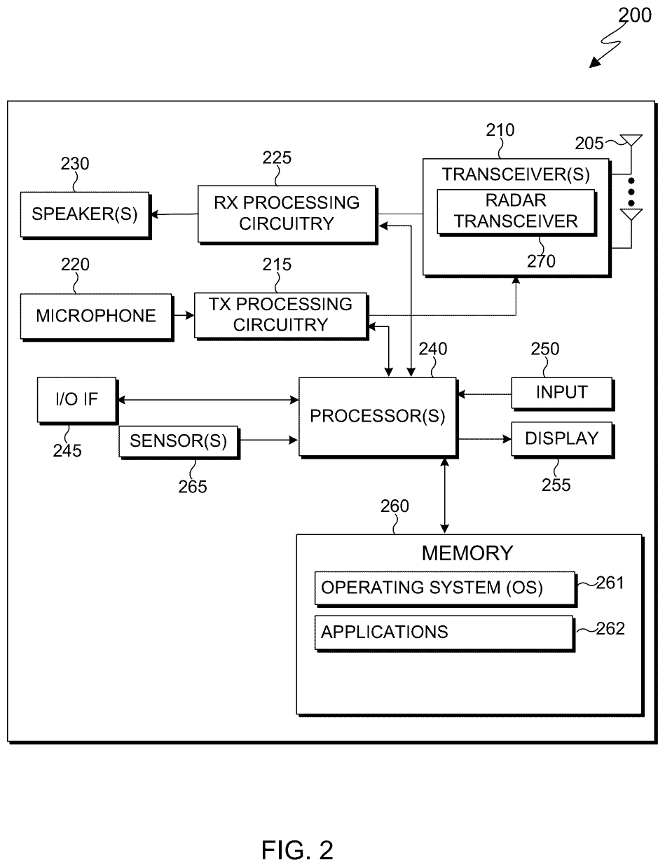

FIG. 2 illustrates an example electronic device according to embodiments of the present disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the AR/VR glasses 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a Wifi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHz, 7 GHz, 8 GHz, 28 GHz, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

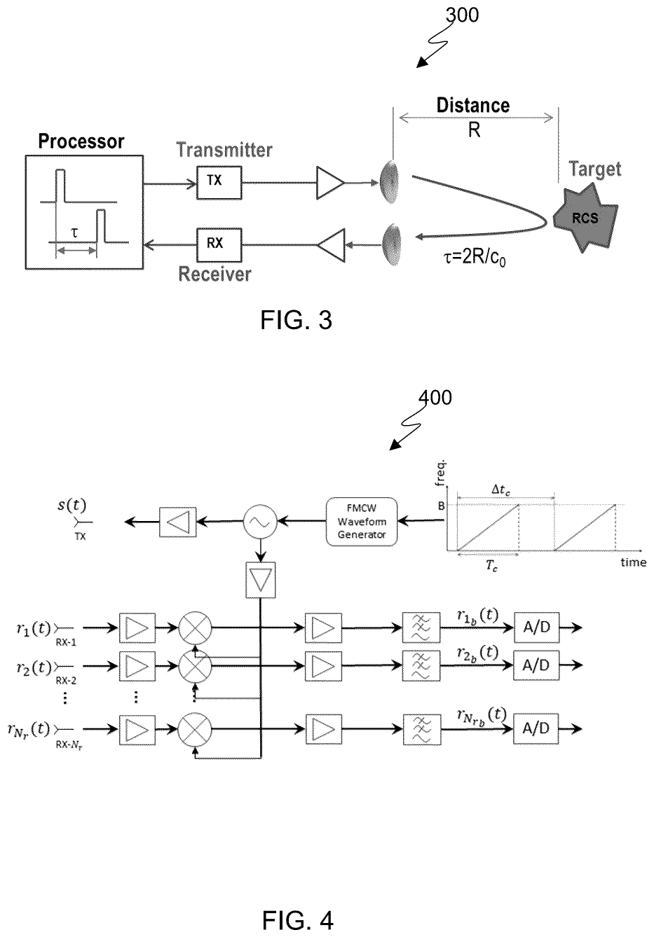

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 3, below, illustrates an example monostatic radar.

In certain embodiments, the radar transceiver 270 can include a transmitter and a receiver. In the radar transceiver 270, the transmitter of can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200. Based on the time differences, the processor 240 can generate an image of the object by mapping the various distances.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

A common type of radar is the “monostatic” radar, characterized by the fact that the transmitter of the radar signal and the receiver for its delayed echo are, for all practical purposes, in the same location.

FIG. 3 illustrates an example monostatic radar 300 according to embodiments of the present disclosure. The embodiment of a monostatic radar 300 of FIG. 3 is for illustration only. Different embodiments of a monostatic radar 300 could be used without departing from the scope of this disclosure.

In the example of FIG. 3 a high level architecture is shown for a common monostatic radar, i.e., the transmitter and receiver are co-located, either by using a common antenna, or are nearly co-located, while using separate, but adjacent antennas. Monostatic radars are assumed coherent, i.e., transmitter and receiver are synchronized via a common time reference.

In a monostatic radar's most basic form, a radar pulse is generated as a realization of a desired “radar waveform”, modulated onto a radio carrier frequency and transmitted through a power amplifier and antenna (shown as a parabolic antenna), either omni-directionally or focused into a particular direction. Assuming a “target” at a distance R from the radar location and within the field-of-view of the transmitted signal, the target will be illuminated by RF power density pₜ (in units of W/m²) for the duration of the transmission. The first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where:
P_{T} . . . transmit power [W],
G_{T}, A_{T} . . . transmit antenna gain [dBi], effective aperture area [m²],
λ . . . wavelength of the radar signal RF carrier signal [m],
R . . . target distance [m].
   In this example, effects of atmospheric attenuation, multi-path propagation, antenna losses, etc. have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver, so only direct reflections will contribute to a detectable receive signal. In essence, the illuminated area(s) of the target with normal vectors pointing back at the receiver will act as transmit antenna apertures with directivities (gains) in accordance with their effective aperture area(s). The reflected-back power is:

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} R C S ,$$

where:
P_{refl} . . . effective (isotropic) target-reflected power [W],
Aₜ, rₜ, Gₜ . . . effective target area normal to the radar direction [m²], reflectivity of the material & shape [0, . . . , 1], and corresponding aperture gain [dBi],
RCS . . . Radar Cross Section [m²].

Note that the radar cross section, RCS, is an equivalent area that scales proportionally to the actual reflecting area-squared, inversely proportionally with the wavelength-squared and is reduced by various shape factors and the reflectivity of the material. For a flat, fully reflecting mirror of area Aₜ, large compared with λ², RCS=4πAₜ²/λ². Due to the material and shape dependency, it is generally not possible to deduce the actual physical area of a target from the reflected power, even if the target distance is known.

The target-reflected power at the receiver location results from the reflected-power density at the reverse distance R, collected over the receiver antenna aperture area:

$${P}_{R} = \frac{{P}_{refl}}{4 π {R}^{2}} {A}_{R} = {P}_{T} \cdot R C S \frac{{A}_{T} {A}_{R}}{4 {πλ}^{2} {R}^{4}} ,$$

where:
P_{R} . . . received, target-reflected power [W],
A_{R} . . . receiver antenna effective aperture area [m²], may be same as A_{T}.
   The radar system is usable as long as the receiver signal exhibits sufficient signal-to-noise ratio (SNR), the particular value of which depends on the waveform and detection method used. Generally, in its simplest form:

$$S N R = \frac{{P}_{R}}{kT \cdot B \cdot F} ,$$

where:
kT . . . Boltzmann's constant x temperature [W/Hz],
B . . . radar signal bandwidth [Hz],
F . . . receiver noise factor (degradation of receive signal SNR due to noise contributions of the receiver circuit itself).

In case the radar signal is a short pulse of duration (width) T_{P}, the delay τ between the transmission and reception of the corresponding echo will be equal to τ=2R/c, where c is the speed of (light) propagation in the medium (air). In case there are several targets at slightly different distances, the individual echoes can be distinguished as such only if the delays differ by at least one pulse width, and hence the range resolution of the radar will be ΔR=cΔτ/2=cT_{P}/2. Further considering that a rectangular pulse of duration T_{P} exhibits a power spectral density P(f)˜(sin(πfT_{P})/(πfT_{P}))² with the first null at its bandwidth B=1/T_{P}, the range resolution of a radar is fundamentally connected with the bandwidth of the radar waveform via:

$$Δ R = c / 2 B .$$

Although FIG. 3 illustrates an example of a monostatic radar 300, various changes may be made to FIG. 3. For example, various changes to transmitter, the receiver, the processor, etc. could be made according to particular needs.

FIG. 4 illustrates an example 400 of a mmWave monostatic FMCW radar according to embodiments of the present disclosure. The embodiment of a radar of FIG. 4 is for illustration only. Different embodiments of a radar could be used without departing from the scope of this disclosure.

In the present disclosure, a mmWave monostatic FMCW radar with sawtooth linear frequency modulation is used. Let the operational bandwidth of the radar be B=fₘᵢₙ−fₘₐₓ, where fₘᵢₙ and fₘₐₓ are minimum and maximum sweep frequencies of the radar, respectively. The radar is equipped with a single transmit and Nᵣ receive antennas. The receive antennas form a uniform linear array (ULA) with spacing

$${d}_{0} = \frac{{λ}_{m ax}}{2} , where {λ}_{ma x} = \frac{c}{{f}_{m i n}}$$

and c is the velocity of the light.

As illustrated in FIG. 4, the transmitter transmits a frequency modulated sinusoid chirp of duration T_{c} over the bandwidth B. Hence, the range resolution of the radar is

$${r}_{min} = \frac{c}{2 B} .$$

In the time domain, the transmitted chirp s(t) is given as:

$$s ( t ) = {A}_{T} cos ( 2 π ( {f}_{min} t + \frac{1}{2} {St}^{2} ) ) ,$$

where A_{T} is the transmit signal amplitude and

$$S = \frac{B}{{T}_{c}}$$

controls the frequency ramp of s(t). The reflected signal from an object is received at the Nᵣ receive antennas. Let the object, such as a finger or hand, is at a distance R₀ from the radar. Assuming one dominant reflected path, the received signal at the reference antenna is given as:

$$r ( t ) = {A}_{R} cos ( 2 π ( {f}_{min} ( t - τ ) + \frac{1}{2} {S ( t - τ )}^{2} ) ) ,$$

where A_{R} is the amplitude of the reflected signal which is a function of A_{T}, distance between the radar and the reflecting object, and the physical properties of the object. Further,

$$τ = \frac{2 {R}_{0}}{c}$$

is the round trip time delay to the reference antenna. The beat signal for the reference antenna is obtained by low pass filtering the output of the mixer. For the reference antenna, the beat signal is given as:

$${r}_{b ( t )} = \frac{{A}_{T} {A}_{R}}{2} cos ( 2 π ( {f}_{{min}^{τ}} + S τ t - \frac{1}{2} S {τ}^{2} ) ) \approx \frac{{A}_{T} {A}_{R}}{2} cos ( 2 π S τ t - 2 π {f}_{min} τ ) ,$$

where the last approximation follows from the fact that the propagation delay is orders of magnitude less than the chirp duration, i.e., τ<<T_{c}. The beat signal has two important parameters, namely the beat frequency

$${f}_{b} = S τ = \frac{S 2 {R}_{0}}{c} ,$$

and the beat phase ϕ_{b}=2πfₘᵢₙτ. The beat frequency is used to estimate the object range R₀. Further, for a moving target, the velocity can be estimated using beat phases corresponding to at least two consecutive chirps. For example, if two chirps are transmitted with a time separation of Δt_{c}>T_{c}, then the difference in beat phases is given as:

$$Δ {ϕ}_{b} = \frac{4 π Δ R}{{λ}_{max}} = \frac{4 π {v}_{0} Δ {t}_{c}}{{λ}_{max}} ,$$

where v₀ is the velocity of the object.

The beat frequency is obtained by taking the Fourier transform of the beat signal that directly gives us the range R₀. To do so, the beat signal r_{b}(t) is passed through an analog to digital converter (ADC) with sampling frequency

$${F}_{s} = \frac{1}{{T}_{s}} ,$$

where Tₛ is the sampling period. As a consequence, each chirp is sampled Nₛ times where T_{c}=NₛTₛ. The ADC output corresponding to the n-th chirp is xₙ∈ [symbol] ^{N}^{ₛ}^{×1} and defined as xₙ=[{x[k, n]}ₖ₌₀^{N}^{ₛ}⁻¹], where x[k, n]=r_{b}(nΔt_{c}+kTₛ). Let the Nₛ-point fast Fourier transform (FFT) output of xₙ be denoted as [symbol] ₙ. Assuming a single object, as has been considered so far, the frequency bin that corresponds to the beat frequency can be obtained as k*=arg max∥ [symbol] ₙ∥². Since the radar resolution is c/2B, the n-th bin of the FFT output corresponds to a target located within

$$[ \frac{kc}{2 B} - \frac{kc}{4 B} , \frac{kc}{2 B} + \frac{kc}{4 B} ]$$

$$for$$

$$1 \leq k \leq {N}_{s} - 1 .$$

As the range information of the object is embedded in [symbol] ₙ, it is also known as the range FFT.

Although FIG. 4 illustrates an example 400 of a radar, various changes may be made to FIG. 4. For example, various changes to the waveform, the frequency, etc. could be made according to particular needs.

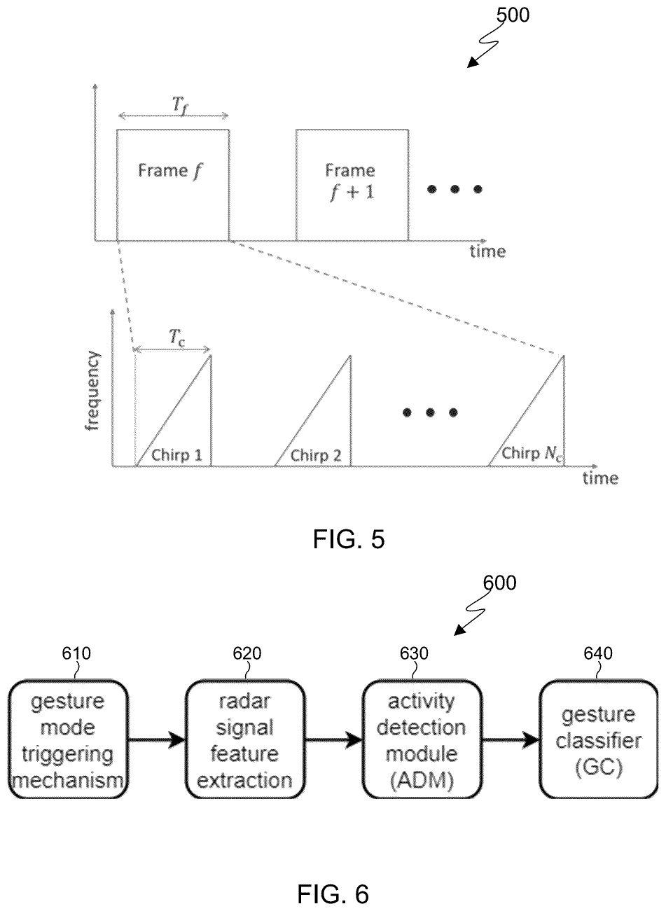

FIG. 5 illustrates an example 500 of a radar transmission timing structure according to embodiments of the present disclosure. The embodiment of a radar transmission timing structure of FIG. 5 is for illustration only. Different embodiments of a radar transmission timing structure could be used without departing from the scope of this disclosure.

To facilitate velocity estimation, the present application adopts a radar transmission timing structure as illustrated in FIG. 5. In the example of FIG. 5, the radar transmissions are divided into frames, where each frame includes N_{c} equally spaced chirps. The range FFT of each chirp gives us the phase information on each range bin. For a given range bin, the Doppler spectrum, which has the velocity information, is obtained by applying N_{c}-point FFT across the range FFTs of chirps corresponding to that range bin. The range-Doppler map (RDM) is constructed by repeating the above step for each range bin. Mathematically R∈ [symbol] ^{N}^{_{c}}^{×N}^{ₛ} as R=[ [symbol] ₀, [symbol] ₁, . . . , [symbol] _{N}_{_{c}}₋₁] is defined. The RDM M is obtained by taking N_{c}-point FFT across all the columns of R. The minimum velocity that can be estimated corresponds to the Doppler resolution, which is inversely proportional to the number of chirps N_{c} and is given as:

$${V}_{min} = \frac{{λ}_{max}}{2 {N}_{c} {T}_{c}} .$$

Further, the maximum velocity that can be estimated is given by:

$${v}_{max} = \frac{{N}_{c}}{2} {v}_{min} = \frac{{λ}_{max}}{4 {T}_{c}} .$$

Although FIG. 5 illustrates an example 500 of a radar transmission timing structure, various changes may be made to FIG. 5. For example, various changes to the waveform, the frequency, etc. could be made according to particular needs.

Since the present application considers a monostatic radar, the RDM obtained using the above-mentioned approach has significant power contributions from direct leakage from the transmitting antenna to the receiving antennas. Further, the contributions from larger and slowly moving body parts such as the fist and forearm can be higher compared to the fingers. Since the transmit and receive antennas are static, the direct leakage appears in the zero-Doppler bin in the RDM. On the other hand, the larger body parts such as the fist and forearm move relatively slowly compared to the fingers. Hence, their signal contributions mainly concentrate at lower velocities. Since the contributions from both these artifacts dominate the desired signal in the RDM, it is better to remove them using appropriate signal processing techniques. The static contribution from the direct leakage is simply removed by nulling the zero-Doppler bin. To remove the contributions from slowly moving body parts, the sampled beat signal of all the chirps is passed in a frame through a first-order infinite impulse response (IIR) filter. For the reference frame f, the clutter removed samples corresponding to all the chirps can be obtained as:

$$[ k , n ] = {x}_{f} [ k , n ] - \overline{{y}_{f}} [ k , n - 1 ]$$

$$\overline{{y}_{f}} [ k , n ] = α {x}_{f} [ k , n ] + ( 1 - α ) \overline{{y}_{f}} k , n - 1 ] ,$$

$$for$$

$$0 \leq k \leq {N}_{s} - 1 ,$$

$$0 \leq n \leq {N}_{c} - 1 ,$$

where y̅_̅{̅f̅}̅[k, n] has contributions from all previous samples of different chirps in the frame.

The following notation is used throughout the present disclosure. Bold lowercase x is used for column vectors, bold uppercase X is used for matrices, non-bold letters x, X are used for scalers. Superscript T and * represent the transpose and conjugate transpose respectively. The fast Fourier transform (FFT) output of a vector x is denoted as [symbol] . The N×N identity matrix is represented by I_{N}, and the N×1 zero vector is 0_{N×1}. The set of complex and real numbers are denoted by [symbol] and [symbol] , respectively.

Gesture-based human-computer interaction (HCI) opens a new era for interacting with smart devices like smart TVs, smart tablet, smart phones, smart watches, smart home devices, AR/VR glasses etc. Among the different sensor modalities, like ultrasonic, IMU, optical, etc., millimeter wave (mmWave) radar based gestural interaction can be a better option for several reasons. For example, mmWave radar's superior spatial and Doppler resolution enable high performance for gesture recognition. Furthermore, radar-based solutions do not have the privacy issues associated with optical sensors-based solutions. Additionally, radar is more affordable for compared to other sensors like LIDAR. Moreover, mmWave radar, has fewer limitations with respect to power consumption and lighting conditions.

A fully functional end-to-end gesture recognition solution may require multiple components that could include:
1. Some mechanism for turning on the gesture recognition system (i.e., triggering the gesture mode).
2. A radar signal feature extractor that processes raw radar measurements into certain format to assist subsequent processing.
3. An activity detection module (ADM) for detecting when a desired gesture was performed,
4. A gesture classifier (GC) that classifies which gesture (in a vocabulary) was performed.

Due to its superb Doppler (speed) measurement capability, radar can capture and distinguish between subtle movements. As such dynamic gestures are suitable for a radar-based gesture recognition solution. An overall system diagram of an example radar-based gesture recognition solution is illustrated in FIG. 6.

FIG. 6 illustrates an example 600 of a radar-based gesture recognition solution according to embodiments of the present disclosure. The embodiment of a radar-based gesture recognition solution of FIG. 6 is for illustration only. Different embodiments of a radar-based gesture recognition solution could be used without departing from the scope of this disclosure.

As illustrated in FIG. 6, a processing pipeline for the gesture recognition solution includes a gesture mode triggering mechanism 610. Gesture mode triggering mechanism 610 may be implemented in several ways. For gesture mode triggering mechanism 610 could be based on proximity detection and/or active applications, etc. In proximity detection-based triggering, the gesture mode is activated only when an object in close proximity to the radar is detected. The proximity detection mode can itself be based on the radar used for gesture detection. The benefit of triggering the gesture mode based on proximity detection comes in reduced power consumption. It is expected that a simpler task of proximity detection can be achieved reliably with radar configurations that have low power consumption. It is only when an object is detected in radar's proximity, that a switch is made to the gesture detection mode, which could be based on a radar configuration that consumes more power. Another possibility for triggering the gesture mode is application based. As an example, dynamic finger gestures may be used with just a few applications, and as such, the gesture mode can be triggered when the user is actively using the application exploiting gestural interaction.

In gesture recognition solution's processing pipeline, once the gesture mode is triggered, the incoming raw radar data is first processed by signal processing module 620 to extract features including Time-velocity diagram (TVD) and Time-angle diagram (TAD), and Time-elevation diagram (TED). Then, the activity detection module (ADM) 630 detects the end of a gesture and determines the portion of data containing a gesture. After that, the portion of data is fed to the gesture classifier (GC) 640 to predict the gesture type. When the gesture recognition system is activated, radar will continuously capture data. GC 640 is triggered when ADM 630 detects a gesture end.

The pipeline as illustrated in FIG. 6 achieves high accuracy on recognizing gestures in the vocabulary. However, this pipeline may misclassify non-gesture (NG) samples as one of the gestures in the vocabulary with high confidence, which causes a lot of False Alarms (FAs) for the applications.

In the present disclosure, the pipeline is updated with additional modules to reject NG samples. Unlike gesture samples, it is impossible to enumerate all types of NG. The NG can be either definable or nondefinable. Definable NG may be rejected by either rule-based solutions or data-driven solutions. However, it is challenging to reject all nondefinable NG. The present disclosure introduces new components to the pipeline in FIG. 6 to reject NGs in multiple stages, including before ADM module 630, within ADM module 630, after ADM module 630 and within GC module 640. The present disclosure primarily focuses on NG rejection schemes after ADM module 630. This is referred to herein as post ADM Gating.

Although FIG. 6 illustrates an example 600 of a radar-based gesture recognition solution, various changes may be made to FIG. 6. For example, various changes to the number of modules, the type of modules, etc. could be made according to particular needs.

The present disclosure considers a micro gesture set where the gestures start and end at the same location and have at least 2 directional motions (like moving from A to B and back to A). Based on these properties, it is easy to handle the transition between different gestures. Additionally, the gesture set is also defined to include a ROI (region-of-interest), i.e., where the gestures should be performed (for example, within 30 cm of the radar boresight). Data is collected for the gesture set and relevant parameters are extracted (e.g., range, angles, etc.). The statistics of the parameters are also summarized, which provides a statistical definition of the gestures. Then, these definitions are used to create gating rules for rejecting NGs. Anything that does not fit within the prototype definitions are considered NGs.

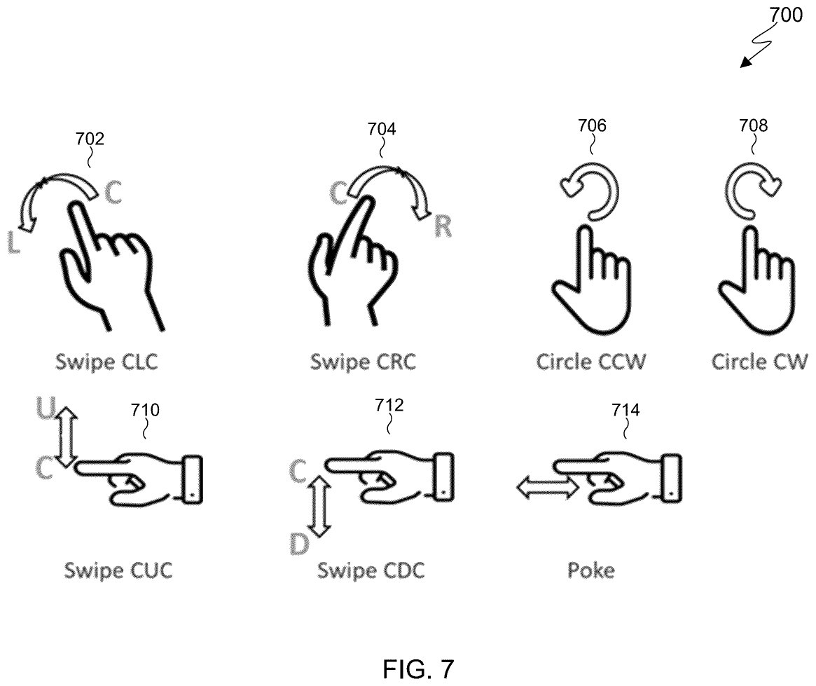

A more concrete example of seven gestures is illustrated in FIG. 7.

FIG. 7 illustrates an example gesture set 700 according to embodiments of the present disclosure. The embodiment of a gesture set of FIG. 7 is for illustration only. Different embodiments of a gesture set could be used without departing from the scope of this disclosure.

FIG. 7 illustrates a set of seven gestures including: Swipe Center-Left-Center (CLC) 702, Swipe Center-Right-Center (CRC) 704, Circle CCW 706, Circle CW 708, Swipe Center-Up-Center (CUC) 710, Swipe Center-Down-Center (CDC) 712, and Poke 714. Gesture set 700 has the following assumptions:
Assumption 1: The gesture is performed around the boresight of the radar and also inside a pre-defined ROI, e.g., the distance of a fingertip to the radar is between 20 cm and 40 cm, the azimuth and elevation angle is between [60°, 120°].
Assumption 2: All gestures return to the starting position or close to starting position at the end. So, the distance and angle (including azimuth and elevation) difference for gesture start and end should be less than certain thresholds.
Assumption 3: The gestures do not have a single slope signature for any feature, including distance, azimuth angle and elevation angle. All the gestures in gesture set 700 either have flat angular/distance features or features with more than 1 slope. For example, the distance feature for Poke 714 has 2 slopes which decrease first and increase later, while azimuth and elevation angular features are close to flat.
Assumption 4: The gestures are micro gestures. The size of the motion, which can be measured with both distance and angle change, should be within a threshold.
Assumption 5: The gesture duration is within a range of values. If an activity is either too long or too short, it is considered as a NG.

Although FIG. 7 illustrates an example gesture set 700, various changes may be made to FIG. 7. For example, various changes to the number of gestures, the type of gestures, etc. could be made according to particular needs.

The present disclosure considers the following example NG scenarios:
Case 1: The user moves their hand from elsewhere into the ROI (e.g., within 30 CM of the radar boresight 30 cm) to perform the gesture and user moves their hand away after performing the gesture. The User could move from/to different positions in different directions.
Case 2: The user switches hand poses or has some smaller perturbation during data capture, e.g., fist/open palm to starting pose, hand transition between different gestures, small finger/hand perturbation.
Case 3: Unintentional user movements including NG motion inside the ROI or outside of the ROI.

Case 1 and case 2 are definable NGs while case 3 are non-definable NGs which is hard to deal with.

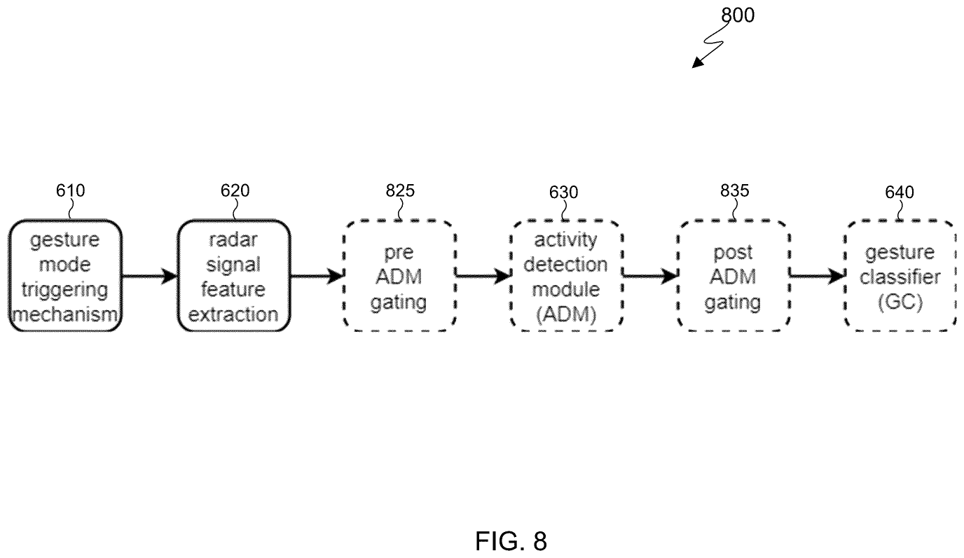

Based on the assumption of the previously described gesture set and NG scenarios, the present disclosure introduces additional modules to reject NGs to the example of FIG. 6 as illustrated in FIG. 8.

FIG. 8 illustrates an example 800 of a radar-based gesture recognition solution according to embodiments of the present disclosure. The embodiment of a radar-based gesture recognition solution of FIG. 8 is for illustration only. Different embodiments of a radar-based gesture recognition solution could be used without departing from the scope of this disclosure.

In the example of FIG. 8, the modules include gesture mode triggering mechanism 610, signal processing module 620, pre-ADM Gating module 825, ADM module 630, Post-ADM Gating module 835, and Gesture Classifier (GC) Module 640. The principle is to reject NG as soon as possible and as many as possible especially in the earlier stages, which is not only energy efficient but also can simplify the modules afterwards.

Pre-ADM Gating module 825 checks if the user is inside the ROI (assumption 1), checks if the length of active frame is in range (assumption 5) and checks if the user is ready to perform the gesture (e.g., a wake up gesture is triggered). The radar signal feature extraction module 620 computes the feature vectors from the radar signal. The feature vectors include distance and angle (both elevation and azimuth) features. From the feature vectors, an estimate is made where the target (e.g., the user's finger) is with respect to radar in both distance and angle. In one embodiment, the average distance/angle of the passed k frames are used as metrics. If the metrics shows that the passed k frames are inside a predefined region, the feature vectors are passed to ADM module 630. Additionally, the number of active frames are counted. An active frame is a frame with activity inside the ROI. If the number of the active frames is too small or too large, the activity will be discarded as NG. Lastly, a wake-up scheme is setup. When the wake-up signal is triggered, ADM module 630 may be triggered. The wake-up scheme could be a specially designed wake up gesture. In one embodiment, the wake-up scheme checks whether there is a target (e.g., a user's finger) inside the ROI or whether a target approaches the ROI and holds still for a period of time. This is interpreted as a sign that the user is ready to perform a gesture. If it is detected that the target exits the ROI for a period of time, the wake-up signal is disabled. In one embodiment, if a target is detected in the ROI in the past a frames, the wake-up signal is enabled. If the target is detected outside of the ROI in the past e frames, the wake-up signal is disabled.

In the example of FIG. 8, a binary ADM classifier module for ADM classifier 630 is retrained to have the ability to tell the feature difference of some definable NGs, especially the ones described in the Case 2 NG scenarios including small finger/hand perturbation, wrist rotating motion to transit between gestures, switching between close fist and open palm to starting pose and etc. Those are potential motions may happen during the real gesture capturing. In one embodiment, data samples for these NG scenarios are added as additional negative samples for the training of the binary ADM classifier module. The remaining ADM modules for ADM classifier 630 are kept the same as in FIG. 6. In one embodiment, for NG samples, the binary ADM classifier will predict 0. With ADM counting schemes, the updated ADM module will no longer detect an activity end for those kind of NG samples.

Post-ADM Gating module 835 checks for gating conditions based on assumption 1, 2, 3, 4, and 5 which mainly deal with Case 1 and part of Case 3 NGs. The concept of Post-ADM Gating is discussed in more detail later herein.

In the example of FIG. 8, GC module 640 is retrained with definable NGs and/or adopts advance deep learning techniques like Openset or out-of-distribution to reject unknown NGs. GC module 640 is data-drive solution. Compared to ADM modules 825 and 835, GC module 640 has stronger input features and a more powerful network. Hence it may have the ability to handle more complicated NG scenarios. Advanced deep learning techniques are utilized to enable GC module 640 to classify NG as NG. In one embodiment NG samples are collected inside of the ROI with some arbitrary motions belonging to the Case 3 NG scenario. These samples are labeled as NG and added into the training dataset. In one embodiment, a technique called OpenMax is used to further identify unknown classes with two main steps. The first step called Meta-recognition determines if a test sample is abnormal/outlier. The second step estimates the OpenMax probability, an extension of softmax using the information from the first step to determine if the test sample belongs to unknown class or not. The retrained GC 640 with additional modules can effectively identify most NGs samples, however it also may lead to a few more missed detections for gesture samples.

Although FIG. 8 illustrates an example 800 of a radar-based gesture recognition solution, various changes may be made to FIG. 8. For example, various changes to the number of modules, the type of modules, etc. could be made according to particular needs.

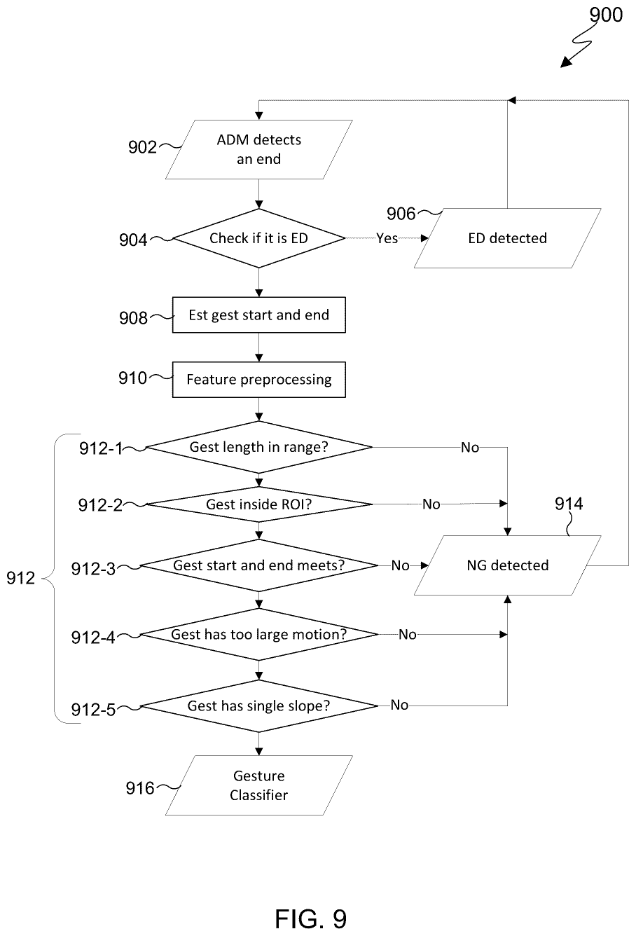

The goal of post ADM gating is to restrict the NG scope by limiting the ROI and by utilizing the gesture features of a gesture set e.g., matching the gesture start and end, micro gesture, gesture length and etc. In one embodiment, a set of gating conditions are made based on these properties. For example, if a certain condition is violated, then the gesture will be rejected as NG and no longer fed to GC 640. An example processing pipeline is illustrated in FIG. 9.

FIG. 9 illustrates a process 900 for post ADM gating according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a process 900 for post ADM gating could be used without departing from the scope of this disclosure.

In the example of FIG. 9, the post ADM gating module (e.g., ADM gating module 835), is triggered if an ADM (e.g., ADM module 630) detects an end at step 902. Once the ADM declares an end, at step 904 a check whether the end is an early detection (ED) is performed. An ED refers to if the ADM declares an end in the middle of an activity. If an ED is identified, at step 906 the ADM decision is overwritten, and some of the ADM statuses are updated so that the ADM module will keep searching the activity end for the upcoming frames. If an ED is not identified, then at step 908 the gesture start and end is estimated based on the input features including distance and angular features. Once the gesture segment is located, at step 910 some preprocessing is further applied on the feature vectors to remove some noise and make the gating condition more robust. Then an activity gating operation is performed at step 912 where conditions are checked one by one including whether gesture length is in range (912-1), whether gesture is performed inside ROI (912-2), whether gesture start and end at approximately the same position (912-3), whether the size of the gesture (either displacement in range or in angle) is too large (912-4) and whether the gesture has a single slope signature (912-5). If NG is identified by any of the conditions, then at step 914 the ADM decision is overwritten and some of the ADM statuses are reset to continue searching activity end for upcoming frames. Otherwise, at step 916 the features are fed to a GC (e.g., GC 640).

Although FIG. 9 illustrates one example of a process 900 for post ADM gating, various changes may be made to FIG. 9. For example, while shown as a series of steps, various steps in FIG. 9 could overlap, occur in parallel, occur in a different order, or occur any number of times.

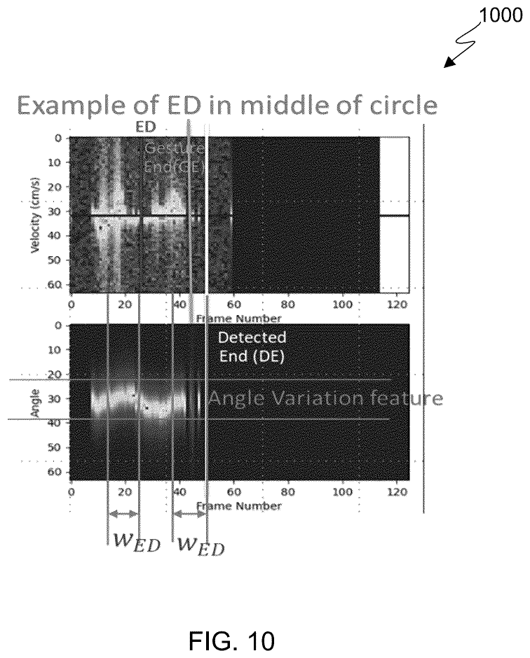

As previously described herein, a post ADM gating module may perform an early detection check (e.g., at step 904 of FIG. 9). For example, the ADM may declare an end in the middle of a gesture when there is an energy dropping pattern in the middle of the motion. An example of ED is illustrated in FIG. 10.

FIG. 10 illustrates an example 1000 of a TVD and a TAD according to embodiments of the present disclosure. The embodiment of a TVD and a TAD of FIG. 10 is for illustration only. Different embodiments of a TVD and a TAD be used without departing from the scope of this disclosure.

In the Example of FIG. 10, the left vertical line in the first plot (TVD) shows where the ADM detects an end. The middle vertical line in the first plot shows the real gesture end (GE). The right vertical line in the first plot shows the possible detected ends (DE) reported by the ADM, which usually happens a few frames after GE. It is hard to differentiate ED with DE using TVD features, especially when there is clutter after GE. In one embodiment, angle variation features are used to identify those ED cases. The key is to differentiate how angles vary for ED versus DE. A good metric is able to avoid overwriting the correctly detected ends and also effectively identify EDs.

Although FIG. 10 illustrates an example 1000 of a TVD and a TAD, various changes may be made to FIG. 10. For example, various changes to the velocity, the angle, the frame numbers, etc. could be made according to particular needs.

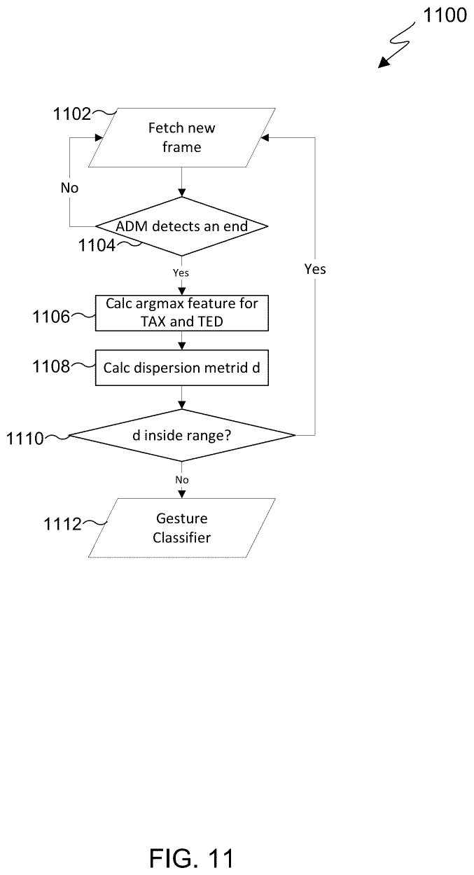

In one embodiment, the dispersion of the angle change in a small window w_{ED} is used to determine whether it is an ED or not. Details of an example angle-based scheme are illustrated in FIG. 11.

FIG. 11 illustrates a process 1100 for angle based early detection identification according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a process 1100 for angle based early detection identification could be used without departing from the scope of this disclosure.

In the example of FIG. 11, new frames are fetched at step 1102 until the ADM detects an end of a gesture at step 1104. Once the ADM detects an end, at step 1106 the 1D argmax feature is calculated for both a TAD and TED in a small window. Assuming the detected end is the last frame, angular features are calculated by looking back w_{ED} frames: f_{tad}=argmax(TAD[:, −w_{ED}:]), f_{ted}=argmax(TAD[:, −w_{ED}:]). The argmax feature for a noise frame is 0. Next, at step 1108, the dispersion metrics for the angular features f_{tad} and f_{ted} are calculated. There are some options for dispersion metrics like variance (var), standard deviation (std), interquartile range (iqr), smoothness, etc. Any metric or a subset of metrics may be picked to set up the conditions. In one embodiment, two metrics are picked including variance and smoothness, where dᵥₐᵣ=var(f_{tad})+var(f_{ted}), dₛₘₒₒₜₕₙₑₛₛ=std(diff(f_{tad}))+std(diff(f_{ted})). Each metric has its own threshold. At step 1110, If the dispersion metrics fall within a dispersion range dᵥₐᵣ∈[νₘᵢₙ, νₘₐₓ] and dₛₘₒₒₜₕₙₑₛₛ∈[sₘᵢₙ, sₘₐₓ], then the end is identified as an ED. Note that, when there is no target being detected in a certain frame, then the angle feature for that frame is 0. For DE, if angle features are either all 0 or have a few 0s for f_{tad}, f_{ted}, then the dispersion metric is either equal to 0 or relatively large. νₘₐₓ and sₘₐₓ may be picked accordingly, so that EDs may be identified and overwriting the correct ADM detection can be avoided, which may lead to longer latency. Some other techniques to identify ED can be used as well. At step 112, if an ED is not detected, the features may be fed to the GC.

Although FIG. 11 illustrates one example of a process 1100 for angle based early detection identification, various changes may be made to FIG. 11. For example, while shown as a series of steps, various steps in FIG. 11 could overlap, occur in parallel, occur in a different order, or occur any number of times.

If a gesture end is not an end, post ADM gating conditions are checked. In one embodiment, the first step is to estimate the gesture start frame gₛ and end frame gₑ (e.g., at step 908 of FIG. 9) based on the input distance vector d_{1×N}_{_{f}}, azimuth angle a_{1×N}_{_{f}}=argmax_{N}_{ₛ}(TAD_{N}_{ₛ}_{×N}_{_{f}}) and elevation angle e_{1×N}_{_{f}}=argmax_{N}_{ₛ}(TED_{N}_{ₛ}_{×N}_{_{f}}), where N_{f} is the number of frames. The ADM detects an end at the last frame. In one embodiment, the gating conditions are calculated upon the gesture start and gesture end. Accurate estimation of gₛ and gₑ leads to an effective gating scheme. In one embodiment, the gesture start and end estimation scheme has two stages.

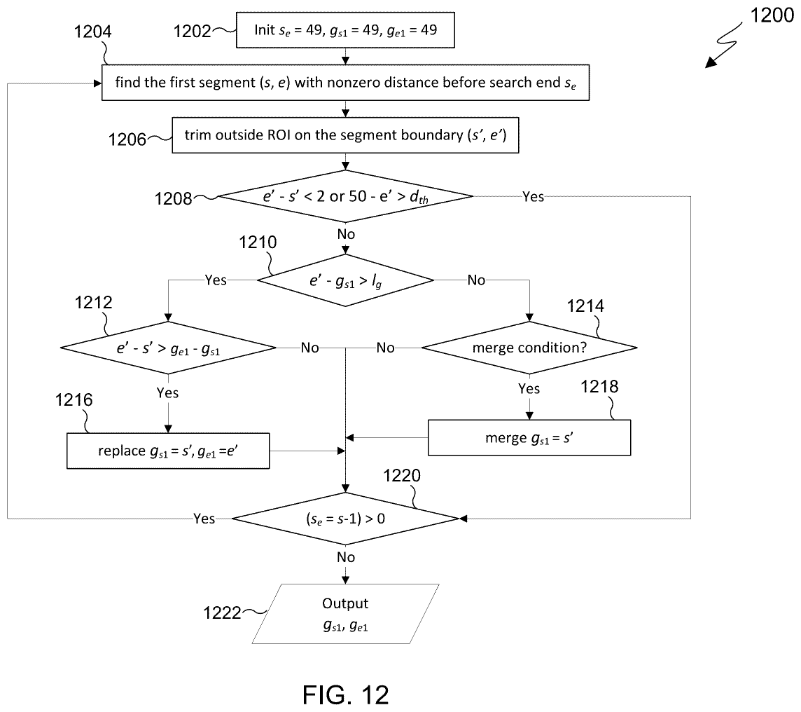

FIG. 12 illustrates a process 1200 for a first stage of estimating gesture start and end according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a process 1200 for a first stage of estimating gesture start and end could be used without departing from the scope of this disclosure.

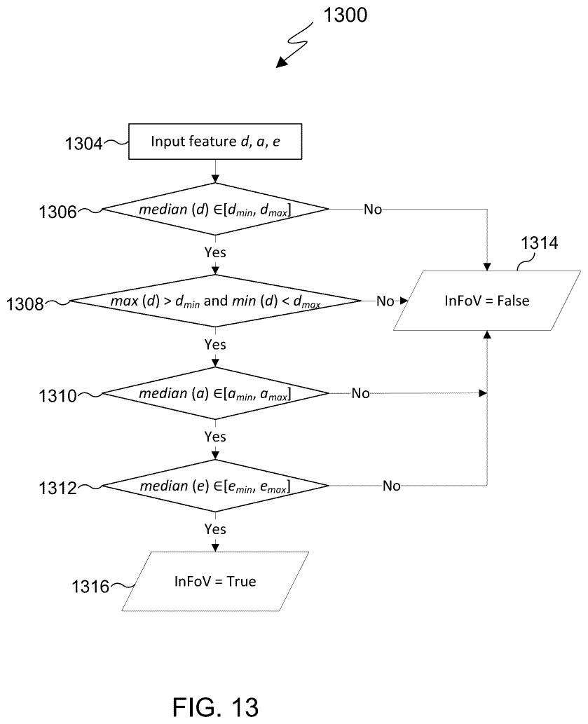

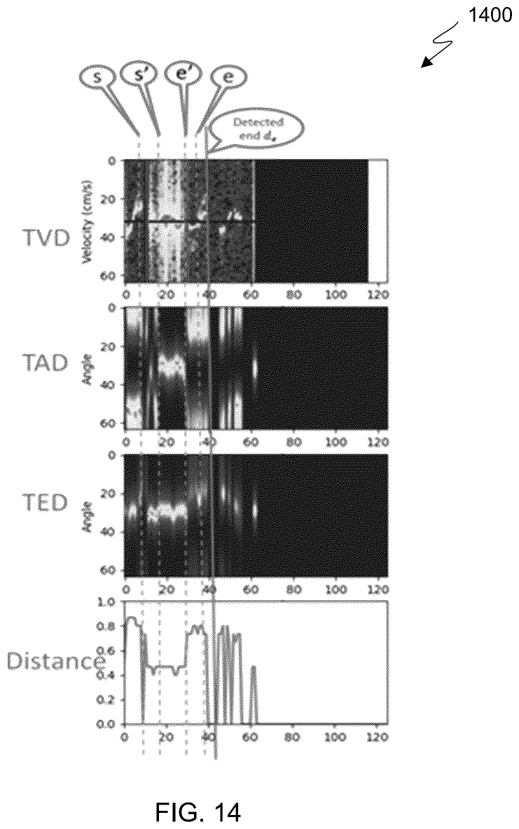

In the example of FIG. 12, the gesture start and end, denoted as gₛ₁, gₑ₁, is roughly estimated by searching valid segments on d_{1×N}_{_{f}} from backward, where, N_{f}=50, Nₛ=64. That is to say, the search pivot is set as the input window end. At step 1202 the process initializes gₛ₁=49, gₑ₁=49. At step 1204, the valid segments [sₛ, sₑ] are segments with consecutive non-zero distance forward from the search pivot. That is to say, the valid segments are segments with consecutive nonzero values, i.e., d[i]>0, ∀i∈[sₛ, sₑ], where d[i]=0 means no target is detected at frame i. The segment extracted from the distance feature could have noise on its boundaries. An example is shown in FIG. 14. At step 1206, the segment is trimmed from both ends to eliminate those frames where the target is outside the ROI (illustrated in FIG. 13) on the boundaries to get ([s_{s′}, s_{e′}]) before updating the segment to [gₛ₁, gₑ₁]. At the beginning of the trimming, the process initializes s_{s′}=s_{s′}s_{e′}=sₑ. The distance feature is expected to smoothly change during the gesture. When a sharp jump happens, the process checks whether the segment before/after the jump is valid or not. Th process searches forward (or backward) from start (or end) and finds a distance difference for the distance feature to determine whether there is a large jump for the distance feature, i.e. abs(d[i]−d[i+1])>dₜₕ₁, ∀i∈[s_{s′}, s_{e′}], where the distance threshold dₜₕ₁ is the threshold of the large jump of the distance feature. If a large jump for the distance feature is found, the process checks whether the segment [s_{s′}, i] (or [i+1, s_{e′}]) is inside the ROI or not. The inside the ROI condition is illustrated in FIG. 13. All the three features are used to define the ROI. If outside the ROI is identified, the boundary is trimmed by updating s_{s′}=i+1 (or s_{e′}=i). After the trimming, one of three operations is performed: a discard operation, replace operation, or a merge operation, to update the segment [s_{s′}, s_{e′}] to the result [gₛ₁, gₑ₁]. At step 1208, if the segment is too short (s_{e′}−s_{s′}<lₛ) or the end of the segment is too far from the current frame (50−s_{e′}>dₜₕ), the segment is discarded at step 1220. lₛ is the minimum frame number for a valid segment. The gesture set may have some gap in the middle, e.g., the gap may happen at the middle of swipe. The length of a segment is about half of a swipe. If the segment is too short, it is considered as not part of a gesture and the gesture discarded at step 1220. The example of FIG. 12 uses lₛ=2. The second condition on dₜₕ is set to avoid late detection. If the distance between the end of segment and the estimated gesture start is larger than l_{g}, and the length of segment is longer than current estimated gesture length, i.e., s_{e′}−gₛ₁>l_{g} and s_{e′}−s_{s′}>gₑ₁−gₛ₁, then the current estimation is replaced with the new segment, i.e., gₛ₁=s_{s′}>gₑ₁=s_{e′}. As earlier described herein, there may be gaps for swipes. l_{g} is used to limit the maximum gap between segments. At step 1210, if the gap is too large, at step 1216 the current estimation is replaced with the segment if at step 1212 the segment is longer than current estimation. Otherwise, the segment is merged at step 1220 to the current results i.e., gₛ₁=s_{s′}, gₑ₁=gₑ₁, if the merge condition is true at step 1216. If two segments belong to one gesture, then they should have similar range and angle. The merge condition is set to confirm that, which also avoids combining two parts with large difference in distance or angle. In one embodiment, the difference of the median value of all three feature vectors are taken as metrics to measure the similarity of two segments. The merge condition is true when the difference of the median value of all feature vectors of the segment and the estimated results are less than their corresponding thresholds. At step 1222, the estimated gesture start and end are output.

Although FIG. 12 illustrates one example of a process 1200 for a first stage of estimating gesture start and end, various changes may be made to FIG. 12. For example, while shown as a series of steps, various steps in FIG. 12 could overlap, occur in parallel, occur in a different order, or occur any number of times.

FIG. 13 illustrates a process 1300 for determining whether a target is within an FoV according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a process 1300 for determining whether a target is within an FoV could be used without departing from the scope of this disclosure.

In the example of FIG. 13, the process begins at step 1304. At step 1304, a radar frames are received that have a distance feature, an azimuth feature, and an elevation feature. A series of checks 1306-1312 are then performed. At step 1306, if the median distance features of the frames fall outside of a distance range, the target is not within the FoV (step 1314). At step 1308, if the max distance feature of the frames is not greater a minimum distance threshold, or the minimum distance feature of the frames is not less than a maximum distance threshold, the target is not within the FoV. At step 1310, if the median azimuth features of the frames fall outside of an azimuth range, the target is not within the FoV. At step 1312, if the median elevation features of the frames fall outside of an elevation range, the target is not within the FoV. Otherwise, if all the checks are passed, the target is determined to be within the FoV (step 1316).

Although FIG. 13 illustrates one example of a process 1300 for a determining whether a target is within an FoV, various changes may be made to FIG. 13. For example, while shown as a series of steps, various steps in FIG. 13 could overlap, occur in parallel, occur in a different order, or occur any number of times.

FIG. 14 illustrates an example 1400 of a distance feature having noise on its boundaries according to embodiments of the present disclosure. The embodiment of the distance feature of FIG. 14 is for illustration only. Different embodiments of a distance feature can be used without departing from the scope of this disclosure.

Although FIG. 14 illustrates an example 1400 of a distance feature having noise on its boundaries, various changes may be made to FIG. 14. For example, various changes to the velocity, the angle, the frame numbers, etc. could be made according to particular needs.

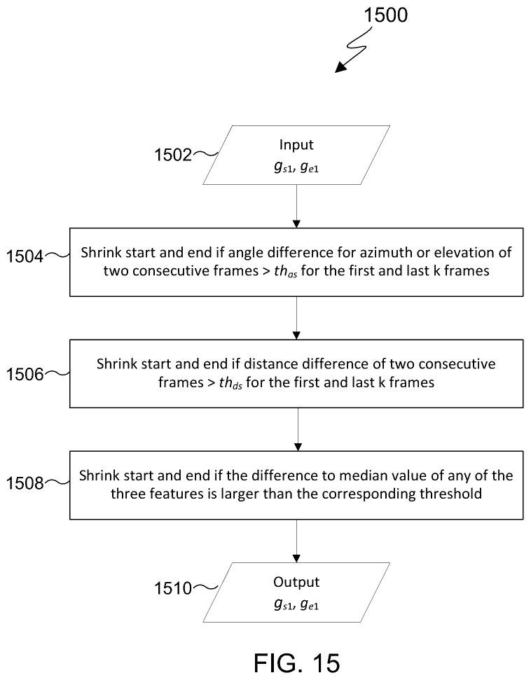

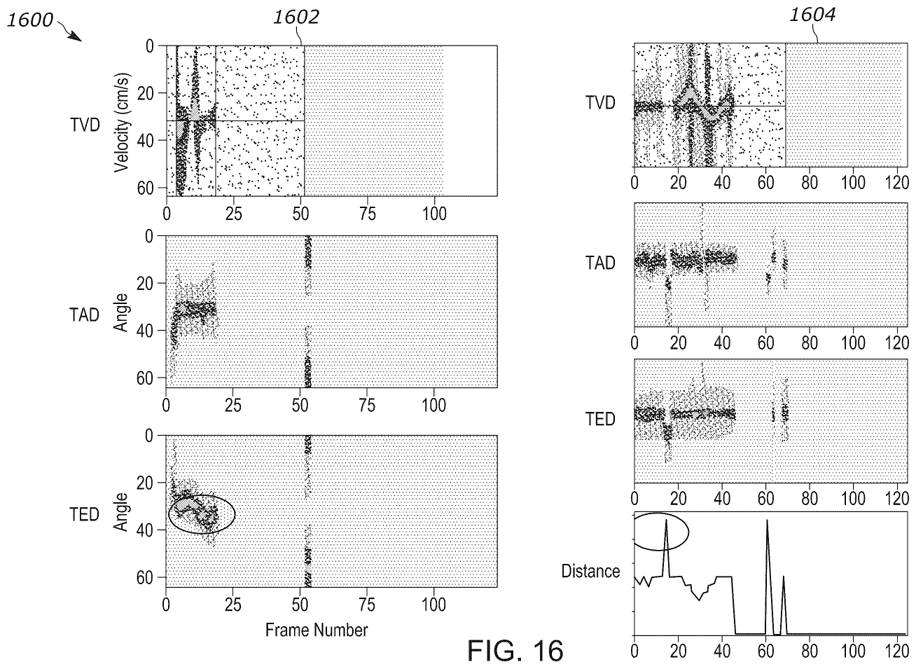

FIG. 15 illustrates a process 1500 for a second stage of estimating gesture start and end according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a process 1500 for a first stage of estimating gesture start and end could be used without departing from the scope of this disclosure.

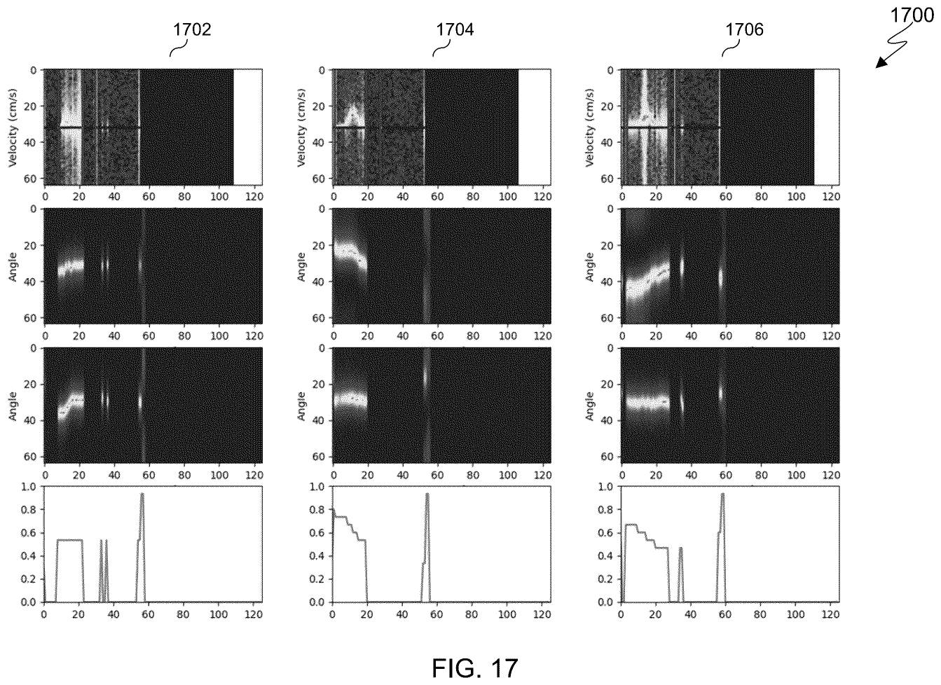

In the example of FIG. 15 the second stage, further optimizes the gesture start and end estimated from the first stage. The gesture start and end estimated in the first stage sometimes may be noisy at the boundaries. Two examples are given in FIG. 16.

FIG. 16 illustrates an example 1600 of boundary noise according to embodiments of the present disclosure. The embodiment of boundary noise of FIG. 16 is for illustration only. Different embodiments of boundary noise can be used without departing from the scope of this disclosure.

In the example of FIG. 16, the left example 1602 has a noisy time TED feature around the gesture end and the right example 1604 has a noisy distance feature around the gesture start.

The second stage is to fine tune the results by cleaning up the noise on the boundaries. The goal is to avoid sharp jumps around the boundary or when the value at the boundary is too far away from the median. Beginning at step 1502, the first and last few frames are checked. If a sharp jump of two consecutive frames for one feature is found, the process shrinks the start and end accordingly. All three features including azimuth angle, elevation angle and distance feature are used in this stage. At step 1504, the process shrinks the start and end if an angle difference for azimuth or elevation of two consecutive frames is greater than an angle threshold thₐₛ for the first and last k frames. At step 1506, the process shrinks the start and end if a distance difference of two consecutive frames is greater than a distance threshold th_{ds} for the first and last k frames. At step 1508, the process shrinks the start and end if the difference to the median value of any of the three features is larger than its corresponding feature threshold. Angle and distance features have different thresholds. At step 1510, the process outputs the estimated gesture start and end.

Although FIG. 15 illustrates one example of a process 1500 for a second stage of estimating gesture start and end, various changes may be made to FIG. 15. For example, while shown as a series of steps, various steps in FIG. 15 could overlap, occur in parallel, occur in a different order, or occur any number of times.

After the above two stages are performed, a good estimation of the gesture start and end gₛ, gₑ can be determined.

Once the gesture start and end have been estimated, all the feature vectors including distance, azimuth angle and elevation angle will have been obtained. As previously described herein, a gesture may have a gap in the middle of the gesture, where the values of feature vectors for those corresponding frames will be 0. Additionally, the feature vector may be noisy. Therefore, some preprocessing may be needed before using the feature vectors to robustly calculate gating conditions. Three processing steps may be performed on the feature vectors. First, all 0 values between gₛ and gₑ may be reset as the larger value of its two neighbors. Second, a median filter can used to remove single spikes. In the examples described herein, kernel size is set to be 3. Other filters to remove the spike noise can be used as well. A median filter is effective for removing single spikes when we kernel size 3 is used. A larger kernel size can help to remove longer spikes. However, a larger kernel size may also cause some unseen issues, such as over smoothing the features. Third, longer spikes can be removed with another method. In one embodiment, the abnormal values are removed by replacing the value according to its “normal” neighbors. Abnormal frames are identified based on the difference to the median value. If the difference is larger than a threshold, it is labeled as abnormal. For each abnormal frame, a search is conducted for its closest “normal” neighbor before and after it and the abnormal frame is replaced with the average value of its “normal” neighbors.

After preprocessing, gating of ADM output may begin. In the example of FIG. 9, the gating conditions are separated into 5 folds.

The first fold checks if the gesture length is in range. (912-1). The Gesture length is calculated as l_{g}=gₑ−gₛ+1. If the motion is either too short or too long, i.e., l_{g}<lₘᵢₙ or l_{g}>lₘₐₓ, it is considered as a NG.

The second fold checks if the gesture is inside the ROI (912-2). To ensure the entire gesture is inside the ROI, the min and max value of each feature should be inside a certain range: max(x)∈[Maxₘᵢₙ^{x}, Maxₘₐₓ^{x}], min(x)∈[Minₘᵢₙ^{x}, Minₘₐₓ^{x}], ∀x∈{d, a, e}, where d, a, e are feature vector of distance, azimuth angle and elevation angle respectively. Max(x)/min(x) can be the maximum/minimum value of the feature vector or the average of k largest/smallest values in feature vector. The example herein uses k=2. Additionally, according to assumption 1 and assumption 2 herein, the gesture start and end should be around the boresight, which is closer to boresight than the min/max value. Tighter bounds may be used to constrain the gesture start and end: start(x)∈[Startₘᵢₙ^{x}, Startₘₐₓ^{x}], end(x)∈[Endₘᵢₙ^{x}, Endₘₐₓ^{x}], ∀x∈d, a, e. The start/end feature can be assigned as the feature vector at frame gₛ and gₑ or the average value of k frame gesture start and end, i.e. start

$$( x ) = \frac{1}{k} {\sum }_{i = 0}^{k - 1} x [ {g}_{s} + i ] , end ( x ) = \frac{1}{k} {\sum }_{i = 0}^{k - 1} x [ {g}_{e} - i ] .$$

The example herein uses k=2.

The third fold checks if the gesture start and end at similar positions (912-3). According to assumption 2, the feature difference of gesture start and end should be less than certain threshold, i.e., abs(start(x)−end(x))<StartEndDiffₘₐₓ^{x}, ∀x∈d, a, e.

The fourth fold checks if motion of the gesture is too large (912-4). The example gesture set described herein only contains micro-gestures, so the size of the motion will not be too large. The size of the motion is measured by range and interquartile range (iqr), i.e. range(x)<Rangeₘₐₓ^{x} and iqr(x)<lqrₘₐₓ^{x}∀x∈d, a, e.

The fifth fold checks if the gesture has a single slope signature (912-5). The feature vector of the example gesture set either is flat or has more than 1 slope. Swipe CRC/CLC has 2 slopes for azimuth angle and flat signature for elevation angle. Swipe CUC/CDC has 2 slopes for elevation angle and is flat for azimuth angle. Poke has flat signature for both azimuth and elevation angle and 2 slopes for distance. Circle CW/CCW has more than 1 slope for all the features. If a single slope signature for any feature is detected for the input motion, then it will be considered as a NG. Note that in this case, when there is no significant slope (i.e., flat), it is considered as having zero slope and not 1 slope. Moving a hand from point A to B will lead to a single slope signature like a half-swipe. Some examples with single slope signatures are shown in FIG. 17.

FIG. 17 illustrates an example 1700 of single slope feature vectors according to embodiments of the present disclosure. The embodiment of single slope feature vectors of FIG. 17 is for illustration only. Different embodiments of single slope feature vectors can be used without departing from the scope of this disclosure.

In the example of FIG. 17, the left example, 1702 has a single slope for elevation angle. The middle example 1704 has single slope for azimuth angle. The right example 1706 has a single slope for the distance feature.

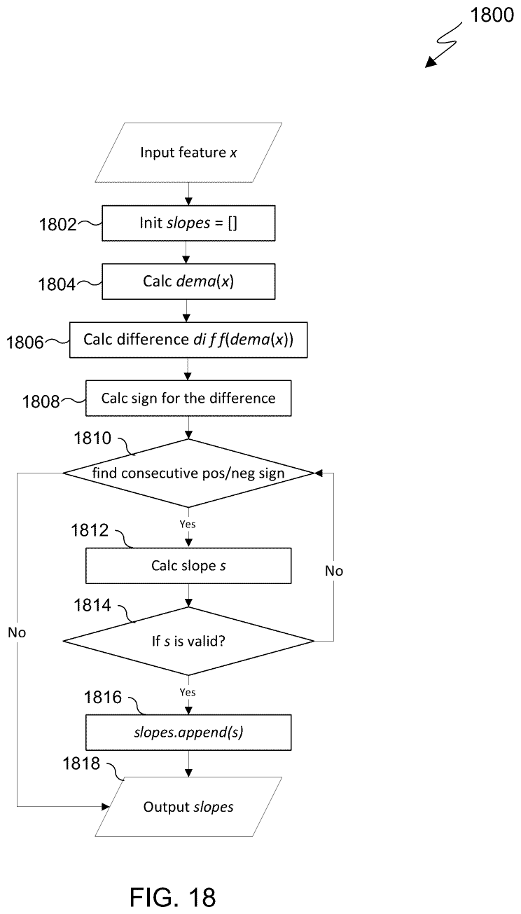

Due to the noise of the feature vector and the limited feature resolution, it is not trivial to estimate the number of slopes directly from the feature vector. Slopes may be estimated using the method of FIG. 18.

FIG. 18 illustrates a process 1800 for estimating slopes according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a process 1800 for estimating slopes could be used without departing from the scope of this disclosure.

In the example of FIG. 18, at step 1804 the input feature x is smoothed with a double exponential moving average to get dema(x). Other smoothing tools can be used as well. Next, at step 1806, the difference if calculated for smoothed feature: diff(dema(x)) and at step 1808, the sign is calculated for the difference

$$sign ( x ) = \{ \begin{matrix}1 if diff ( dema ( x ) ) > th \\ - 1 if diff ( dema ( x ) ) < - th , \\ 0 , otherwise\end{matrix}$$

where th controls the size of 0-band to avoid small perturbation after the smoothing. After that, at step 1810, a search is conducted for the segments with consecutive positive sign/negative sign from the beginning. Note that 0s are included when searching for a consecutive positive/negative sign. A positive/negative segment begins with a positive/negative element and stops before an element with negative/positive sign. Once a segment is found, the slope s is calculated at step 1812 if the segment has more than 2 frames. At step 1814, the slope is considered as valid if the following conditions stand:
a) sₘᵢₙ<|s|<sₘₐₓ, which is to avoid flat slope or sharp change, e.g., in our experiment, we use sₘᵢₙ=0.1, sₘₐₓ=4.
b) len(slopes)==0 or |slopes[−1]−s|>s_{diff}, a slope which is too close to the last slope is ignored.
c) len(slopes)==0 or sign (slope[−1])!=sign(s), a slope with the same sign as the last slope is ignored.
   After searching to the end of the feature vector, the estimated slopes are output at step 1818. If only 1 slope is found, then the gesture is considered as a NG. In one embodiment, the slope estimation process for feature x is only performed if the range of feature x is larger than a threshold, i.e. range(x)>thₛₗₒₚₑ(x), which reduces the overhead from performing the slope estimation and reduces misdetections caused by bumpy features.

Although FIG. 18 illustrates one example of a process 1800 for estimating slopes, various changes may be made to FIG. 18. For example, while shown as a series of steps, various steps in FIG. 18 could overlap, occur in parallel, occur in a different order, or occur any number of times.

If any of the above conditions are violated, the activity is considered as a NG and not fed it the GC.

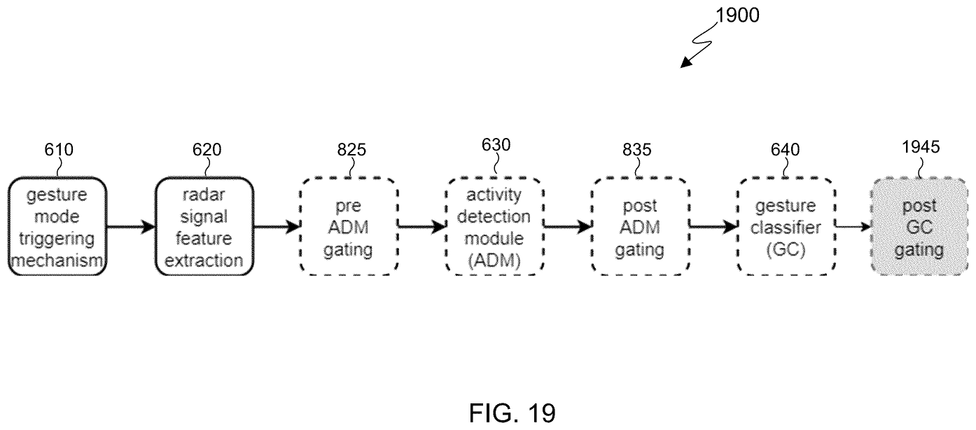

In the Post ADM Gating scheme discussed herein, each condition uses the same bound for all the input samples, which means the bound may be effective for some gesture types but not for the others. For example, Swipe CRC/CLC has larger variation in azimuth angle than Swipe CUC/CDC, which means Rangeₘₐₓ^{a} for Swipe CUC/CDC is not that effective. Similarly, Rangeₘₐₓ^{e} is not that effective for Swipe CLC/CRC. The distance related bounds e.g., Minₘᵢₙ^{d}, Minₘₐₓ^{d}, Maxₘᵢₙ^{d}, Maxₘₐₓ^{d}, Rangeₘₐₓ^{d} and etc. may be effective for Poke but not for other gestures. As described herein, adaptive bounds for different inputs are setup, which allows configuring more effective bounds without causing additional misdetections. However, it is a challenge to determine how to adaptively pick the bonds based on the input, because at this stage, the gesture type is unknown. One possible solution is to apply the gating scheme again after GC module with gesture-based conditions as illustrated in FIG. 19. Another possible solution is to apply the adaptive gating schemes after ADM module as described later herein.

FIG. 19 illustrates an example 1900 of a radar-based gesture recognition solution according to embodiments of the present disclosure. The embodiment of a radar-based gesture recognition solution of FIG. 19 is for illustration only. Different embodiments of a radar-based gesture recognition solution could be used without departing from the scope of this disclosure.

In the example of FIG. 19, the modules include gesture mode triggering mechanism 610, signal processing module 620, pre-ADM Gating module 825, ADM module 630, Post-ADM Gating module 835, Gesture Classifier (GC) Module 640, and post GC gating module 1945. In the example of FIG. 19, The gesture-based conditions will be more effective than the general conditions previously described herein to reject NGs. In that case, misclassifications of NGs may be rejected in the GC and further rejected after the GC.

Although FIG. 19 illustrates an example 1900 of a radar-based gesture recognition solution, various changes may be made to FIG. 19. For example, various changes to the number of modules, the type of modules, etc. could be made according to particular needs.

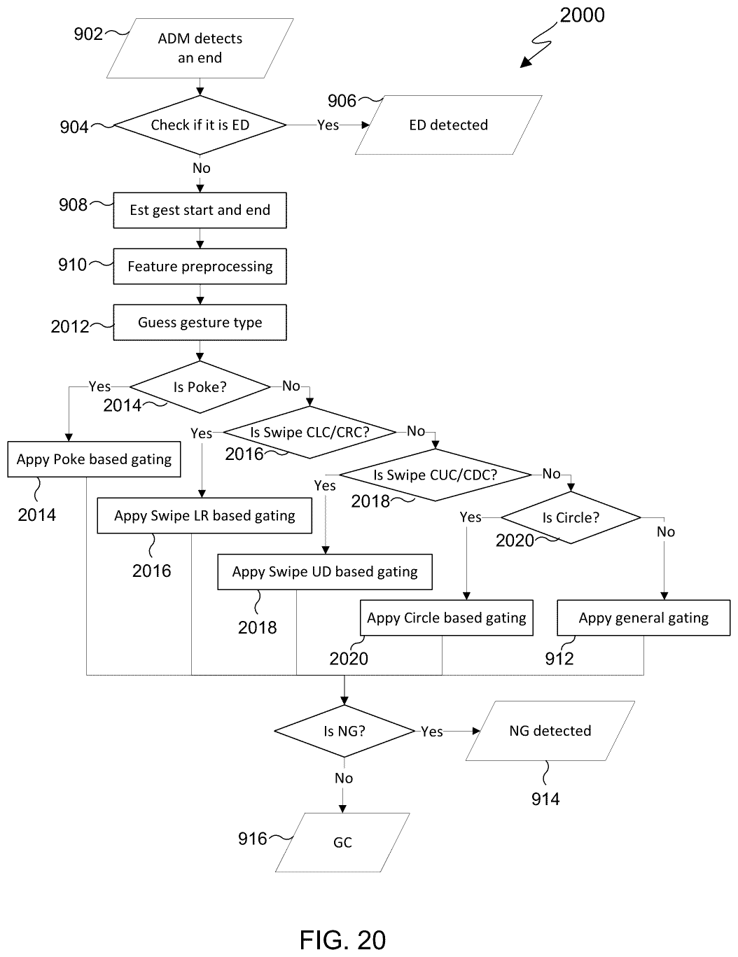

As previously described, adaptive gating schemes may be applied after the ADM module. In one embodiment, gesture-based NG conditions and general NG conditions are used. For the given samples, which set of conditions to use may be determined based on the features. In this manner, the gesture type may be confidently guessed based on the input features, and gesture-based conditions may be used. Otherwise, general conditions may be used as described herein. In the present disclosure, this is referred to as gesture-based post ADM gating. Am example of gesture-based post ADM gating is shown in FIG. 20.

FIG. 20 illustrates a process 2000 for gesture-based post ADM gating according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a process 2000 for gesture-based post ADM gating could be used without departing from the scope of this disclosure.

In the example of FIG. 20, steps 902-916 are performed similar as described regarding FIG. 9. At step 2012 a guess is made regarding gesture type based on the features received after feature preprocessing in step 910. The gesture type may be estimated at this this stage as follows:
Poke (step 2014): if the distance variation is larger than a threshold, the azimuth angle variation is less than a threshold and the elevation variation is less than a threshold, then the gating conditions designed for Poke gesture may be used.
Swipe CLC/CRC step 2016): if the azimuth variation is larger than a threshold, the elevation angle variation is smaller than a threshold, then the gating conditions for Swipe CLC/CRC may be used.
Swipe CUC/CDC (step 2018): if the elevation angle variation is larger than a threshold, the azimuth angle variation is smaller than a threshold, then the gating conditions for Swipe CUC/CDC may be used.
Circle (step 2020): if the azimuth variation is larger than a threshold and the elevation angle variation is larger than a threshold, then the gating conditions for Circle may be used.

To measure the input feature (x) variations, the following metrics may be used: range(x), iqr(x), var(x), smooth(x) and etc. A combination of a subset of those metrics can also be used. Other metrics can be used as well. The concept is to use some unique features of each gesture/gesture subset to differentiate with the other gestures. In the above embodiment, the gestures are separated into 4 categories. However, the gestures may be grouped in other ways.

The gesture-based post ADM gating scheme has tighter bounds to identify more NGs while without causing additional MDs.

Although FIG. 20 illustrates one example of a process 2000 for gesture-based post ADM gating, various changes may be made to FIG. 20. For example, while shown as a series of steps, various steps in FIG. 20 could overlap, occur in parallel, occur in a different order, or occur any number of times.

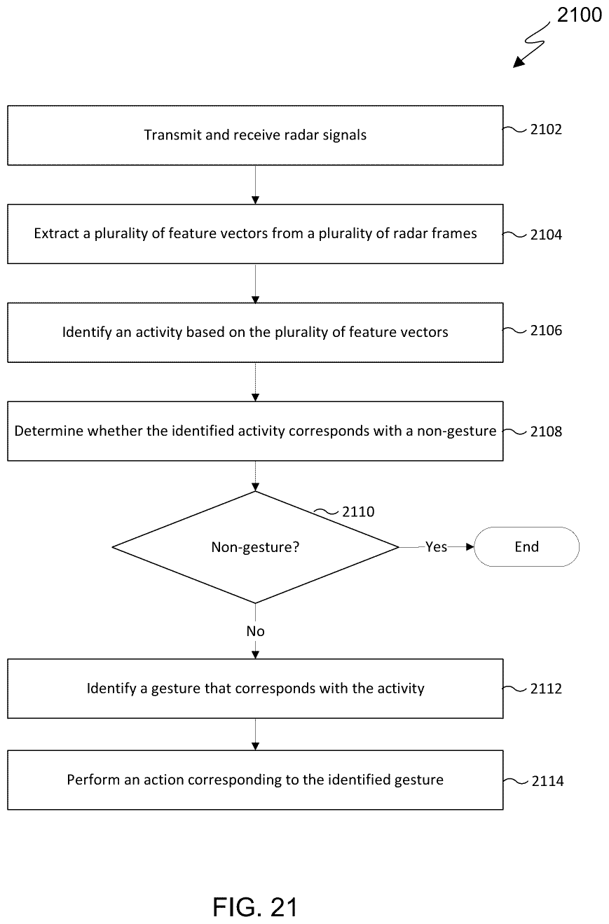

FIG. 21 illustrates a method 2100 for non-gesture rejections in gesture recognition according to embodiments of the present disclosure. An embodiment of the method illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of burst-based non-gesture rejection could be used without departing from the scope of this disclosure.

As illustrated in FIG. 21, the method 2100 begins at step 2102. At step 2102, an electronic device transmits and receives radar signals. At step 2104, the electronic devices extracts a plurality of feature vectors from a plurality of radar frames corresponding to the radar signals. At step 2106, the electronic device identifies an activity based on the plurality of feature vectors. At step 2108 the electronic device determines the identified activity corresponds with a non-gesture. At step 2110, if the identified activity corresponds with a non-gesture, method 2100 ends. Otherwise, at step 2112, the electronic device identifies a gesture that corresponds with the activity. Finally, at step 2114, the electronic devices performs an action corresponding with the identified gesture.

Although FIG. 21 illustrates one example of a method 2100 for non-gesture rejections in gesture recognition, various changes may be made to FIG. 21. For example, while shown as a series of steps, various steps in FIG. 21 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a transceiver configured to transmit and receive radar signals; and
a processor operatively coupled to the transceiver, the processor configured to:
extract a plurality of feature vectors from a plurality of radar frames corresponding to the radar signals;
identify an activity based on the plurality of feature vectors;
determine whether the identified activity corresponds with a non-gesture; and
if the activity fails to correspond with a non-gesture:
identify a gesture that corresponds with the activity; and
perform an action corresponding with the identified gesture.

2. The electronic device of claim 1, wherein to determine whether the identified activity corresponds with a non-gesture, the processor is further configured to:
determine whether the identified activity is an early detection; and
if the identified activity is not an early detection:
estimate a gesture start and a gesture end;
preprocess the plurality of feature vectors; and
perform an activity gating operation based on the preprocessed plurality of feature vectors.

3. The electronic device of claim 2, wherein to determine whether the identified activity is an early detection, the processor is further configured to:
detect a gesture end;
determine angular features for a time-angle diagram (TAD) and a time-elevation diagram (TED) corresponding with the identified activity;
determine a dispersion metric based on the angular features; and
determine whether the dispersion metric falls within a dispersion range,
wherein if the dispersion metric falls within the dispersion range, the identified activity is an early detection.

4. The electronic device of claim 2, wherein to preprocess the plurality of feature vectors, the processor is further configured to:
for each feature vector of the plurality of feature vectors:
if a value of the feature vector indicates a failure to detect activity, change the value indicating a failure to detect activity to a value of a closest neighbor feature vector;
filter the feature vector with a median filter; and
if the value of the feature vector is an abnormal value, change the abnormal value to a value of a closest neighbor having a normal value.

5. The electronic device of claim 2, wherein to perform the activity gating operation, the processor is further configured to:
determine whether the identified activity corresponds with a non-gesture based on at least one of:
a gesture length;
a region of interest (ROI);
a gesture start and gesture end;
a gesture motion size; and
a gesture slope signature.

6. The electronic device of claim 2, wherein to perform the activity gating operation, the processor is further configured to:
determine that the identified activity corresponds with a gesture;
identify a gesture type corresponding with the identified activity; and
perform a gesture gating operation based on the gesture type.

7. The electronic device of claim 2, wherein to estimate the gesture start and the gesture end, the processor is further configured to:
set an input window end to be a search pivot; and
until the search pivot reaches an input window start:
identify a segment of the input window with consecutive non-zero distance forward from the search pivot;
trim the segment to exclude outside region of interest (ROI) frames from both ends of the segment;
update the gesture start and the gesture end based on the trimmed segment;
update the search pivot according to a trimmed segment start; and
determine whether the search pivot has reached the input window start.

8. The electronic device of claim 7, wherein updating the gesture start with the trimmed segment comprises one of a replace operation or a merge operation.

9. The electronic device of claim 7, wherein to estimate the gesture start and end, the processor is further configured to:
if, for a predetermined number of frames from the input window start and input window end, an angle difference for azimuth or elevation for two consecutive frames is greater than an angle threshold, shrink the input window start and input window end;
if, for the predetermined number of frames from input window start and input window end, a distance difference of two consecutive frames is greater than a distance threshold, shrink the input window start and input window end; and
if a difference to a median value of a an angle or distance feature is larger than a corresponding feature threshold, shrink the input window start and input window end.

10. The electronic device of claim 1, wherein the processor is further configured to perform a gesture gating operation based on the identified gesture, wherein the action corresponding with the identified gesture is performed based on a result of the gesture gating operation.

11. A method of operating an electronic device, the method comprising:
transmitting and receiving radar signals;
extracting a plurality of feature vectors from a plurality of radar frames corresponding to the radar signals;
identifying an activity based on the plurality of feature vectors;
determining whether the identified activity corresponds with a non-gesture; and
if the activity fails to correspond with a non-gesture:
identifying a gesture that corresponds with the activity; and
performing an action corresponding with the identified gesture.

12. The method of claim 11, wherein determining whether the identified comprises:
determining whether the identified activity is an early detection; and
if the identified activity is not an early detection:
estimating a gesture start and a gesture end;
preprocessing the plurality of feature vectors; and
performing an activity gating operation based on the preprocessed plurality of feature vectors.

13. The method of claim 12, wherein determining whether the identified activity is an early detection comprises:
detecting a gesture end;
determining angular features for a time-angle diagram (TAD) and a time-elevation diagram (TED) corresponding with the identified activity;
determining a dispersion metric based on the angular features; and
determining whether the dispersion metric falls within a dispersion range,
wherein if the dispersion metric falls within the dispersion range, the identified activity is an early detection.

14. The method of claim 12, preprocessing the plurality of feature vectors comprises:
for each feature vector of the plurality of feature vectors:
if a value of the feature vector indicates a failure to detect activity, changing the value indicating a failure to detect activity to a value of a closest neighbor feature vector;
filtering the feature vector with a median filter; and
if the value of the feature vector is an abnormal value, changing the abnormal value to a value of a closest neighbor having a normal value.

15. The method of claim 12, wherein performing the activity gating operation comprises:
determining whether the identified activity corresponds with a non-gesture based on at least one of:
a gesture length;
a region of interest (ROI);
a gesture start and gesture end;
a gesture motion size; and
a gesture slope signature.

16. The method of claim 12, wherein performing the activity gating operation comprises:
determining that the identified activity corresponds with a gesture;
identifying a gesture type corresponding with the identified activity; and
performing a gesture gating operation based on the gesture type.

17. The method of claim 12, estimating the gesture start and the gesture end comprises:
setting an input window end to be a search pivot; and
until the search pivot reaches an input window start:
identifying a segment of the input window with consecutive non-zero distance forward from the search pivot;
trimming the segment to exclude outside region of interest (ROI) frames from both ends of the segment;
updating the gesture start and the gesture end based on the trimmed segment;
updating the search pivot according to a trimmed segment start; and
determining whether the search pivot has reached the input window start.

18. The method of claim 17, wherein updating the gesture start with the trimmed segment comprises one of a replace operation or a merge operation.

19. The method of claim 17, wherein estimating the gesture start and end further comprises:
if, for a predetermined number of frames from the input window start and input window end, an angle difference for azimuth or elevation for two consecutive frames is greater than an angle threshold, shrinking the input window start and input window end;
if, for the predetermined number of frames from input window start and input window end, a distance difference of two consecutive frames is greater than a distance threshold, shrinking the input window start and input window end; and
if a difference to a median value of an angle or distance feature is larger than a corresponding feature threshold, shrinking the input window start and input window end.

20. The method of claim 11, further comprising performing a gesture gating operation based on the identified gesture, wherein the action corresponding with the identified gesture is performed based on a result of the gesture gating operation.
